(19) United States
(12) Patent Application Publication
(10) Pub. No.: US 2021/0173632 A1
(43) Pub. Date: Jun. 10, 2021

(54) TECHNOLOGIES FOR PROVIDING REMOTE OUT-OF-BAND FIRMWARE UPDATES

(71) Applicant: INTEL CORPORATION, Santa Clara, CA (US)

(72) Inventors: Che-Ming HSU, Shanghai (CN); Chuan-Wei LEE, Taipei City, Taiwan (CN)

(73) Assignee: Intel Corporation, Santa Clara, CA (US)

(21) Appl. No.: 16/969,730

(22) PCT Filed: May 14, 2018
(86) PCT No.: PCT/CN2018/086691

§ 371 Date: Aug. 13, 2020

(51) Int. Cl. G06F 8/654

(52) U.S. Cl. CPC G06F 8/654; G06F 9/4401

(57) ABSTRACT

Technologies for providing remote out-of-band firmware up-dates include a compute device. The compute device includes an out-of-band remote debug logic unit, a data path management logic unit connected to the out-of-band remote debug logic unit, and a firmware memory connected to the data path management logic unit. The out-of-band remote debug logic unit is configured to receive, from a remote compute device, a request to up-date firmware of the compute device. The request includes updated firmware. The out-of-band remote debug logic unit is also configured to send, in response to receipt of the request and in a first format, a write request to the data path management logic unit. The data path management logic unit is configured to convert the write request from the first format to a second format. The firmware memory is responsive to messages in the second format. The data path management logic unit is further configured to send the converted request to the firmware memory to write the updated firmware to the firmware memory. Other embodiments are also described and claimed.

### BACKGROUND

Some compute devices, such as compute devices in a data center, may include a logic, unit capable of communicating with a remote compute device (e.g., a management server) to report the status of and enable remote control of certain aspects of the compute device, such as fan speed. The logic unit may carry out such operations out-of-band (e.g., using a data stream that is independent of a main in-band data stream typically used by the compute device for communications). However, while an administrator of the data center may be able to perform some management-related operations through out-of-band communications with the logic unit of the compute device, the administrator is typically unable to update a firmware (e.g., software programmed into a non-volatile memory of a hardware device) of the compute device through the logic unit, as the logic unit is designed to operate with a data path (e.g., a JTAG interface) that is incompatible with (e.g., not understood by and/or not physically connected with) the firmware memory. As such, in instances in which the basic input/output system (BIOS) or other firmware of the compute device is corrupted or otherwise preventing the compute device from booting and utilizing in-band communications, an administrator is unable to remotely update the firmware to enable the compute device to boot.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a system for providing remote out-of-band firmware updates to compute devices in a data center;

FIG. 2 is a simplified block diagram of at least one embodiment of a compute device of the system of FIG. 1; and

FIGS. 3-5 are a simplified block diagram of at least one embodiment of a method for enabling remote out-of-band firmware updates that may be performed by the compute device of FIGS. 1-2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

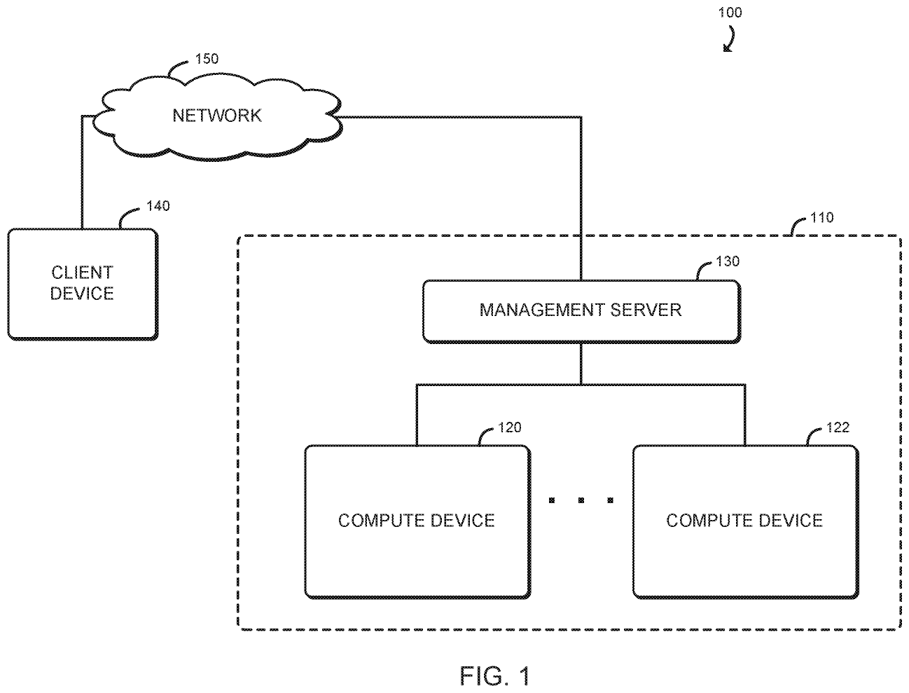

Referring now to FIG. 1, a system 100 for providing remote out-of-band (e.g., using a data stream that is independent of a main data stream typically used by the compute device for communications) firmware updates to compute devices includes a data center 110, such as a cloud data center, in which a management server 130 is in communication with a set of compute devices 120, 122. As used herein, a remote update refers to performing an update from a device (e.g., the management server 130) that is connected to the target compute device (e.g., the compute device whose firmware is to be updated) through a network. Each compute device 120, 122, in operation, may execute one or more applications (e.g., in one or more virtual machines) on behalf of a client device 140, which, in the illustrative embodiment, is in communication with the management server 130 and/or the compute devices 120, 122 through a network 150. The management server 130, in operation, may receive status data (e.g., temperatures, fan speeds, error messages, etc.) from each compute device 120, 122 and send, in response to the status data, requests to perform one or more operations (e.g., to adjust a fan speed, to reboot, etc.) using out-of-band communications (e.g., even when an operating system of the compute device 120, 122 has not been booted). Furthermore, and unlike typical systems in which the firmware of a compute device cannot be updated remotely if the compute device is not booted, in the illustrative embodiment, the management server 130 may send an updated firmware to one or more of the compute devices 120, 122 to perform a firmware update (e.g., to overwrite a corrupt BIOS that is preventing the compute device 120, 122 from booting). As such, an operator of the data center 110 may more efficiently perform managements operations on the compute devices 120, 122 (e.g., without expending the time and/or funds to have a technician flash the firmware memory with an updated firmware in person). As described in more detail herein, each compute device 120, 122 enables such remote out-of-band firmware updates by routing a firmware update request received by an out-of-band remote debug logic unit of the compute device 120, 122 through a data path management logic unit (e.g., a platform controller hub (PCH)) that is capable of communicating with the firmware memory of the compute device 120, 122.

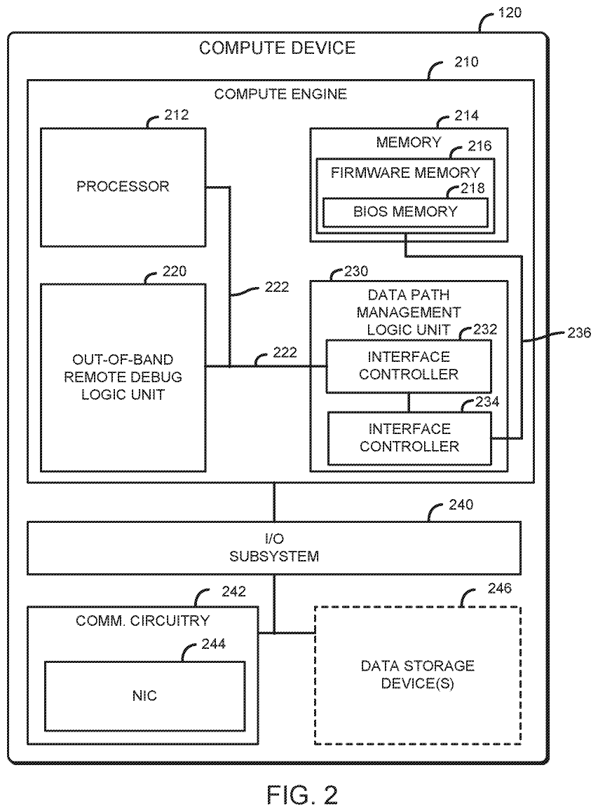

Referring now to FIG. 2, the compute device 120 may be embodied as any type of device (e.g., a computer) capable of performing the functions described herein, receiving, from a remote compute device, a request to update firmware of the compute device 120, sending, in response to receipt of the request and in one format (e.g., a JTAG format), a write request from an out-of-band remote debug logic unit to a data path management logic unit of the compute device 120, converting, with the data path management logic unit, the write request from the one format (e.g., a JTAG format) to a second format (e.g., an SPI format), and sending, with the data path management logic unit, the converted request to a firmware memory of the compute device 120 to write a firmware update to the firmware memory.

As shown in FIG. 2, the illustrative compute device 120 includes a compute engine 210, an input/output (I/O) subsystem 240, communication circuitry 242, and one or more data storage devices 246. Of course, in other embodiments, the compute device 120 may include other or additional components, such as those commonly found in a computer (e.g., a display, peripheral devices, etc.). Additionally, in some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. In the illustrative embodiment, the compute engine 210 includes or is embodied as a processor 212, a memory 214, an out-of-band remote debug logic unit 220, which may also be referred to as a baseboard management controller (BMC) or a management block, and a data path management logic unit 230, which may also be referred to as a platform controller hub (PCH). The processor 212 may be embodied as any type of processor capable of performing the functions described herein. For example, the processor 212 may be embodied as a multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, 3D crosspoint memory Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the main memory 214 may be integrated into the processor 212. In operation, the main memory 214 may store various software and data used during operation such as applications, programs, libraries, and drivers. In the illustrative embodiment, the memory 214 includes firmware memory, which may be embodied as any memory configured to store firmware (e.g., a flash memory). For example, and as shown in FIG. 2, in the illustrative embodiment, the firmware memory 216 includes a BIOS memory 218, which may be embodied as any memory configured to store BIOS firmware (e.g., a BIOS image).

The out-of-band remote debug logic unit 220 may be embodied as any device (e.g., a processor, a microcontroller, an ASIC, etc.) capable of communicating out-of-band with a remote compute device (e.g., the management server 130) to perform management and debugging functions (e.g., which may be referred to as At-Scale operations) with one or more components of the compute device 120 even when the processor is unpowered and/or the compute device 120 is in an unbootable state (e.g., if the BIOS is corrupted). The out-of-band remote debug logic unit 220 may receive a request from the remote compute device (e.g., the management server 130) to update (e.g., replace) firmware, such as the BIOS, to enable the compute device 120 to boot. The out-of-band remote debug logic unit 220 is connected to several components of the compute device, including the processor 212 and the data path management logic unit 230 through one type of data path 222 (e.g., a JTAG bus). The data path management logic unit 230, may be embodied as any device (e.g., a processor, a microcontroller, an ASIC, etc.) that controls communications through data paths within the compute device 120 and, in the illustrative embodiment, includes an interface controller 232 coupled to another interface controller 234 through an internal bus, which may be referred to as an on-chip system fabric (IOSF). The controller 232 may be embodied as any device (e.g., processor, microcontroller, ASIC, etc.) capable of communicating using a communication standard of the data path 222 (e.g., JTAG) and of the internal bus, and the controller 234 may be embodied as any device (e.g., processor, microcontroller, ASIC, etc.) capable of communicating using the communication standard of the internal bus and of at least one other communication standard (e.g. SPI) associated with a data path 236 that connects the data path management logic unit 230 to the firmware memory 216. As such, and as described in more detail herein, the data path management logic unit 230 may enable the out-of-band remote debug logic unit 220 to operate as a master device in the SPI protocol and write to and/or read from the firmware memory 216 on behalf of the remote device (e.g., the management server 130).

The compute engine 210 is communicatively coupled to other components of the compute device 120 via the I/O subsystem 240, which may be embodied as circuitry and/or components to facilitate input/output operations with the compute engine 210 (e.g., with the processor 212 and/or the main memory 214) and other components of the compute device 120. For example, the I/O subsystem 240 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 240 may form a portion of a system-on-a-chip (SoC) and be incorporated, along with one or more of the processor 212, the main memory 214, and other components of the compute device 120, into the compute engine 210.

The communication circuitry 242 may be embodied as any communication circuit, device, or collection thereof, capable of enabling communications over the network 150 between the compute device 120 and another compute device (e.g., the management server 130, the client device 140, the compute device 122, etc.). The communication circuitry 242 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 242 includes a network interface controller (NIC) 244, which may also be referred to as a host fabric interface (HFI). The NIC 244 may be embodied as one or more add-in-boards, daughter cards, network interface cards, controller chips, chipsets, or other devices that may be used by the compute device 120 to connect with another compute device (e.g., the management server 130, the client device 140, the compute device 122, etc.). In some embodiments, the NIC 244 may be embodied as part of a system-on-a-chip (SoC) that includes one or more processors, or included on a multichip package that also contains one or more processors. In some embodiments, the NIC 244 may include a local processor (not shown) and/or a local memory (not shown) that are both local to the NIC 244. In such embodiments, the local processor of the, NIC 244 may be capable of performing one or more of the functions of the compute engine 210 described herein. Additionally or alternatively, in such embodiments, the local memory of the NIC 244 may be integrated into one or more components of the compute device 120 at the board level, socket level, chip level, and/or other levels.

The one or more illustrative data storage devices 246 may be embodied as any type of devices configured for short-term or long-term storage of data such as, for example, memory devices and circuits, memory cards, hard disk drives, solid-state drives, or other data storage devices. Each data storage device 246 may include a system partition that stores data. and firmware code for the data storage device 246. Each data storage device 246 may also include one or more operating system partitions that store data files and executables for operating systems.

The compute device 122, the management server 130, and the client device 140 may have components similar to those described in FIG. 1 with reference to the compute device 120. The description of those components of the compute device 120 is equally applicable to the description of components of the compute device 122, the management server 130, and the client device 140 and is not repeated herein for clarity of the description. Further, it should be appreciated that any of the compute devices 120, 122, the management server 130, and the client device 140 may include other components, sub-components, and devices commonly found in a computing device, which are not discussed above in reference to the compute device 120 and not discussed herein for clarity of the description.

As described above, the compute devices 120, 122, the management server 130, and the client device 140 are illustratively in communication via the network 150, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), digital subscriber line (DSL) networks, cable networks (e.g., coaxial networks, fiber networks, etc.), or any combination thereof.

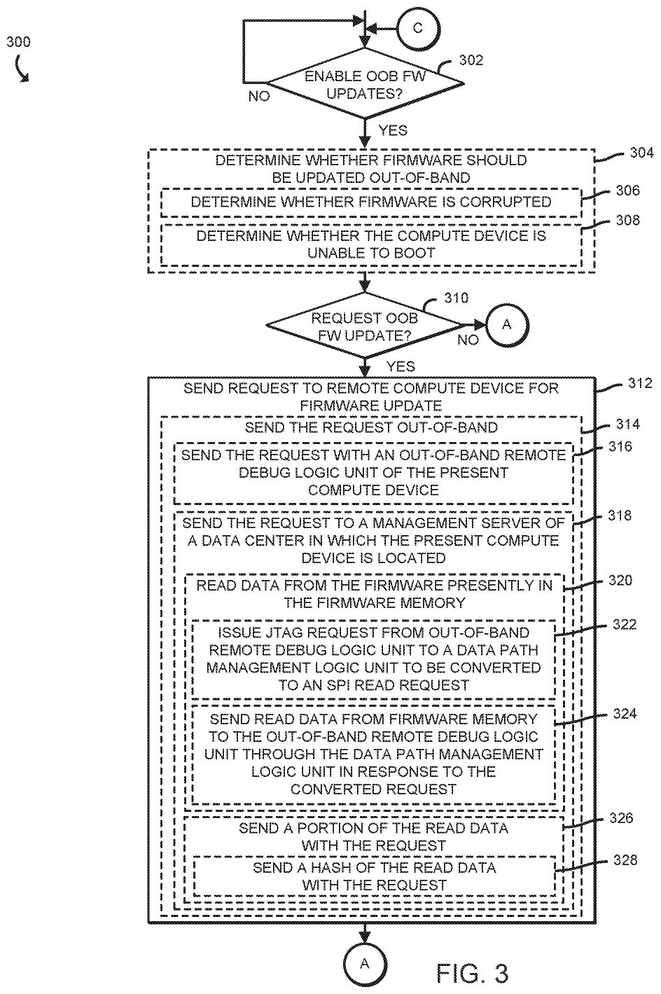

Referring now to FIG. 3, the compute device 120, in operation, may execute a method 300 for providing remote (e.g., at the request of a remote compute device, such as the management server 130) out-of-band firmware updates. The method 300 begins with block 302, in which the compute device 120 determines whether to enable remote out-of-band firmware updates. In the illustrative embodiment, the compute device 120 may determine whether to enable remote out-of-band firmware updates to be performed in response to a determination that the compute device 120 is equipped with the out-of-band remote debug logic unit 220 and the data path management logic unit 230. In other embodiments, the compute device 120 may make the determination based on other factors. Regardless, in response to a determination to enable remote out-of-band firmware updates, the method 300, in the illustrative embodiment, advances to block 304, in which the compute device 120 may determine whether firmware (e.g., a BIOS) should be updated out-of-band. In doing so, and as indicated in block 306, the compute device 120 determines whether the firmware is corrupted (e.g., by generating a hash of the firmware and determining whether the generated hash matches a reference hash of the firmware). As indicated in block 308, the compute device 120 may determine whether the compute device 120 is able to boot (e.g., using a BIOS in the BIOS memory 218), and, if not, that the firmware (e.g., the BIOS) should be updated out-of-band. In block 310, the compute device 120 determines the subsequent course of action based on a determination, if any, made in block 304. For example, the compute device 120 may be configured to request an out-of-band firmware update in response to a determination that the firmware is corrupted and/or that the compute device 120 is unable to boot using the existing BIOS. In other embodiments, the compute device 120 may not expressly request a firmware update but may otherwise indicate (e.g., in a status message to the management server 130) that a firmware update is needed (e.g., by reporting that the compute device 120 is unable to boot). Regardless, in response to a determination to request an out-of-band firmware update, the method 300 advances to block 312 in which the compute device 120 sends a request to a remote compute device for a firmware update.

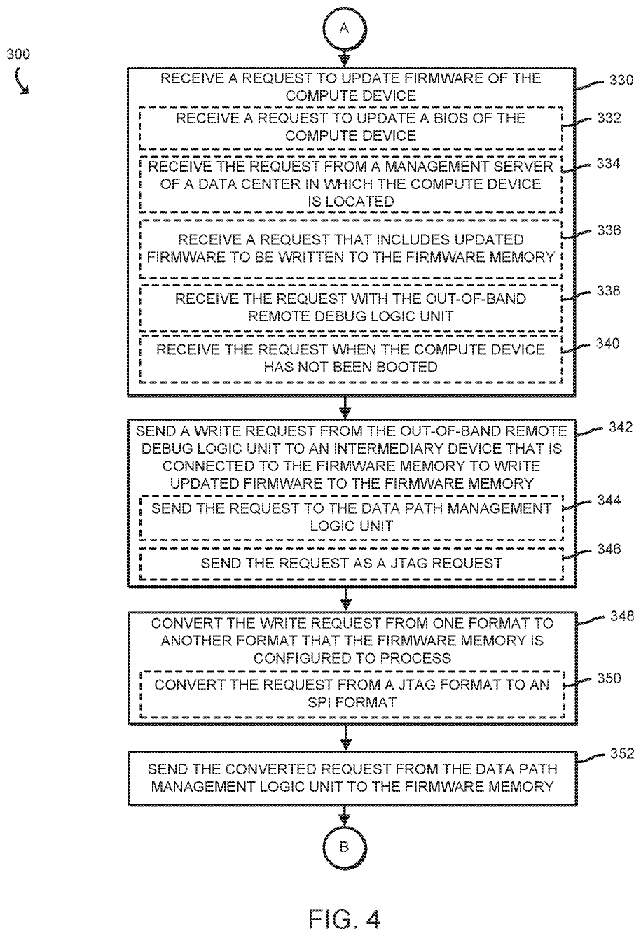

In sending the request, and as indicated in block 314, the compute device 120 sends the request out-of-band (e.g., using a data stream that is independent of a main in-band data stream typically used by the compute device 120 for communications), As indicated in block 316, the compute device 120, in the illustrative embodiment, sends the request using the out-of-band remote debug logic unit 220. In the illustrative embodiment, the compute device 120 sends the request to a management server (e.g., the management server 130) of a data center (e.g., the data center 110) in which the compute device 120 is located, as indicated in block 318. In some embodiments, the compute device 120 may read data from the firmware presently in the firmware memory 216 in the process of generating the request to be sent, as indicated in block 320. For example, and as indicated in block 322, the compute device 120 may issue a JTAG request from the out-of-band remote debug logic unit 220 to the data path management logic unit 230 to be converted to an SPI read request. The data path management logic unit 230 may then perform the conversion and send the corresponding SPI read request to the firmware memory 216 (e.g., the BIOS memory 218) and send the read data from the firmware memory 216 (e.g., in response to receipt of the SPI read request) back to the out-of-band remote debug logic unit 220, as indicated in block 324. Further, the compute device 120 may send a portion of the read data with the request (e.g., a set of data, such as globally unique identifier in a header or another portion of the firmware, that identifies the firmware to be replaced), as indicated in block 326. In some embodiments, the compute device 120 sends a hash of the read data with the request to the remote compute device (e.g., the management server 130), as indicated in block 328. Subsequently, or if the compute device 120 determined in block 310 not to request an out-of-band firmware update, the method 300 advances to block 330 of FIG. 4, in which the compute device 120 may receive a request to update firmware of the compute device 120.

Referring now to FIG. 4, in receiving the request to update firmware of the compute device 120, the compute device 120 may receive a request to update the BIOS of the compute device 120, as indicated in block 332. As indicated in block 334, the compute device 120 may receive the request from a management server (e.g., the management server 130) of a data center (e.g., the data center 110) in which the compute device 120 is located. In the illustrative embodiment, the compute device 120 receives a request that includes the updated firmware to be written to the firmware memory 216, as indicated in block 336. Further, in the illustrative embodiment, the compute device 120 receives the request with the out-of-band remote debug logic unit 220, as indicated in block 338. As indicated in block 340, the compute device 120 may receive the request when the compute device 120 has not been booted (e.g., when the compute device 120 is unable to boot due to a corrupted or otherwise faulty BIOS). Subsequently, the method 300 advances to block 342, in which the compute device 120 sends a write request from the out-of-band remote debug logic unit 220 to an intermediate device that is connected to the firmware memory 216 to write the updated firmware to the firmware memory 216. In doing so, in the illustrative embodiment, the out-of-band remote debug logic unit 220 sends the request to the data path management logic unit 230 (e.g., the intermediate device is the data path management logic unit 230), as indicated in block 344. Further, in the illustrative embodiment, the out-of-band remote debug logic unit 220 sends the request as a JTAG request (e.g., the request is in a JTAG format and is sent through the data path 222, which in the illustrative embodiment, is a JTAG bus), as indicated in block 346.

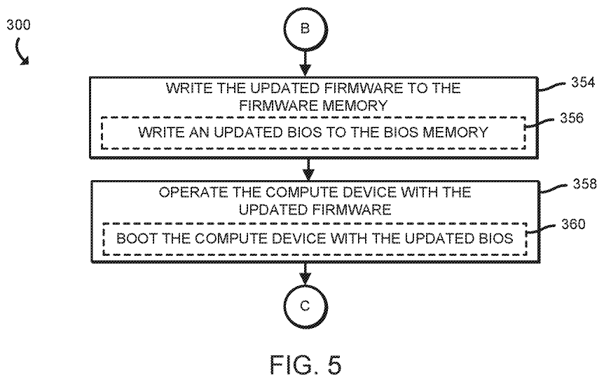

In block 348, the compute device 120 converts (e.g., with one or more of the interface controllers 232, 234 of the data path management logic unit 230) the write request from one format to another format that the firmware memory 216 is configured to process. In doing so, and as indicated in block 350, the compute device 120 (e.g., the data path management logic unit 230) converts the request from a JTAG format to an SPI format, as indicated in block 350. Afterwards, in block 352, the compute device 120 sends the converted request from the data path management logic unit 230 to the firmware memory 216. Subsequently, the method 300 advances to block 354 of FIG. 5, in which the compute device 120 writes the updated firmware to the firmware memory 216.

Referring now to FIG. 5, in writing the updated firmware, the compute device 120, in the illustrative embodiment, writes an updated BIOS to the BIOS memory 218, as indicated in block 356. Subsequently, the method 300 advances to block 358, in which the compute device 120 operates with the updated firmware, as indicated in block 358. In doing so, the compute device 120, in the illustrative embodiment, boots using the updated BIOS, as indicated in block 360. The method 300 may subsequently loop back to block 302 of FIG. 3, in which the compute device 120 determines whether to continue to enable out-of-band firmware updates.

### EXAMPLES

Illustrative examples of the technologies disclosed herein are provided below. An embodiment of the technologies may include any one or more, and any combination of, the examples described below.

Example 1 includes a compute device comprising an out-of-band remote debug logic unit; a data path management logic unit connected to the out-of-band remote debug logic unit; and a firmware memory connected to the data path management logic unit; wherein the out-of-band remote debug logic unit is configured to receive, from a remote compute device, a request to update firmware of the compute device, wherein the request includes updated firmware; and send, in response to receipt of the request and in a first format, a write request to the data path management logic unit; and the data path management logic unit is configured to convert the write request from the first format to a second format, wherein the firmware memory is responsive to messages in the second format; and send the converted request to the firmware memory to write the updated firmware to the firmware memory.

Example 2 includes the subject matter of Example 1, and wherein the firmware memory is configured to write the updated firmware to the firmware memory.

Example 3 includes the subject matter of any of Examples 1 and 2, and wherein the firmware memory is further configured to write an updated basic input/output system (BIOS) to the firmware memory.

Example 4 includes the subject matter of any of Examples 1-3, and wherein the compute device further comprises circuitry configured to send, before the compute device has been booted, a request to the remote compute device for a firmware update.

Example 5 includes the subject matter of any of Examples 1-4, and wherein the circuitry is further configured to determine whether the compute device is unable to boot and to send, in response to a determination that the compute device is unable to boot, the request to the remote compute device.

Example 6 includes the subject matter of any of Examples 1-5, and wherein the circuitry is further configured to send the request to a management server of a data center in which the compute device is located.

Example 7 includes the subject matter of any of Examples 1-6, and wherein the out-of-band remote debug logic unit is further configured to send a read request to the data path management logic unit to read data from the firmware memory; and the data path management logic unit is further configured to send read data from the firmware memory to the out-of-band remote debug logic unit in response to the read request.

Example 8 includes the subject matter of any of Examples 1-7, and wherein the out-of-band remote debug logic unit is further configured to receive the request to update the firmware of the compute device when the compute device has not been booted.

Example 9 includes the subject matter of any of Examples 1-8, and further including circuitry configured to boot the compute device with the updated firmware.

Example 10 includes the subject matter of any of Examples 1-9 and wherein the out-of-band remote debug logic unit is further configured to receive a request to update a basic input/output system (BIOS) of the compute device.

Example 11 includes the subject matter of any of Examples 1-10, and wherein the data path management logic unit is further configured to convert the request from a Joint Test Action Group (JTAG) format to a Serial Peripheral Interface (SPI) format.

Example 12 includes a method comprising receiving, with an out-of-hand remote debug logic unit of a compute device, a request from a remote compute device to update firmware of the compute device, wherein the request includes updated firmware; sending, with the out-of-band remote debug logic unit and in response to receipt of the request and in a first format, a write request to a data path management logic, unit of the compute device; converting, with the data path management logic unit, the write request from the first format to a second format, wherein a firmware memory of the compute device is responsive to messages in the second format; and sending, with the data path management logic unit, the converted request to the firmware memory to write the updated firmware to the firmware memory.

Example 13 includes the subject matter of Example 12, and wherein writing the updated firmware to the firmware memory comprises writing an updated basic input/output system (BIOS) to the firmware memory.

Example 14 includes the subject matter of any of Examples 12 and 13, and further including sending, by the compute device and before the compute device has been booted, a request to the remote compute device for a firmware update.

Example 15 includes the subject matter of any of Examples 12-14, and further including determining, by the compute device, whether the compute device is unable to boot and wherein sending the request to the remote compute device comprises sending, in response to a determination that the compute device is unable to boot, the request to the remote compute device.

Example 16 includes the subject matter f any of Examples 12-15, and wherein sending the request to the remote compute device comprises sending the request to a management server of a data center in which the compute device is located.

Example 17 includes the subject matter of any of Examples 12-16, and further including sending, by the out-of-band remote debug logic unit, a read request to the data path management logic unit to read data from the firmware memory; and sending, by the data path management logic unit, read data from the firmware memory to the out-of-band remote debug logic unit in response to the read request.

Example 18 includes the subject matter of any of Examples 12-17, and wherein receiving the request to update the firmware of the compute device comprises receiving the request when the compute device has not been booted.

Example 19 includes the subject matter of any of Examples 12-18, and further including booting the compute device with the updated firmware.

Example 20 includes the subject matter of any of Examples 12-19, and wherein receiving the request to update the firmware of the compute device comprises receiving a request to update a basic input/output system (BIOS) of the compute device.

Example 21 includes the subject matter of any of Examples 12-20, and wherein converting the write request from the first format to a second format comprises converting the request from a Joint Test Action Group (JTAG) format to a Serial Peripheral Interface (SPI) format.

Example 22 includes one or more machine-readable storage media comprising a plurality of instructions stored thereon that, in response to being executed, cause a compute device to perform the method of any of Examples 12-21.

Example 23 includes a compute device comprising means for performing the method of any of Examples 12-21.

1-23. (canceled)

24. A compute device comprising:
an out-of-band remote debug logic unit;
a data path management logic unit connected to the out-of-band remote debug logic unit through a first data path; and
a firmware memory connected to the data path management logic unit through a second data path;
wherein the out-of-band remote debug logic unit is to:
receive, from a remote compute device, a request to update firmware of the compute device, wherein the request includes updated firmware; and
send, in response to receipt of the request and in a first format, a write request to the data path management logic unit; and
the data path management logic unit is to:
convert the write request from the first format to a second format, wherein the firmware memory is responsive to messages in the second format; and
send the converted request to the firmware memory to write the updated firmware to the firmware memory.

25. The compute device of claim 24, wherein the firmware memory is to write the updated firmware to the firmware memory.

26. The compute device of claim 25, wherein to write the updated firmware to the firmware memory comprises to write an updated basic input/output system (BIOS) to the firmware memory.

27. The compute device of claim 24, wherein the compute device further comprises circuitry to send, before the compute device has been booted, a request to the remote compute device for a firmware update.

28. The compute device of claim 27, wherein the circuitry is further to determine whether the compute device is unable to boot and wherein to send the request to the remote compute device comprises to send, in response to a determination that the compute device is unable to boot, the request to the remote compute device.

29. The compute device of claim 27, wherein to send the request to the remote compute device comprises to send the request to a management server of a data center in which the compute device is located.

30. The compute device of claim 24, wherein the out-of-band remote debug logic unit is further to send a read request to the data path management logic unit to read data from the firmware memory; and
the data path management logic unit is further to send read data from the firmware memory to the out-of-band remote debug logic unit in response to the read request.

31. The compute device of claim 24, wherein to receive the request to update the firmware of the compute device comprises to receive the request when the compute device has not been booted.

32. The compute device of claim 31, further comprising to circuitry boot the compute device with the updated firmware.

33. The compute device of claim 24, wherein to receive the request to update the firmware of the compute device comprises to receive a request to update a basic input/output system (BIOS) of the compute device.

34. The compute device of claim 24, wherein to convert the write request from the first format to a second format comprises to convert the request from a Joint Test Action Group (JTAG) format to a Serial Peripheral Interface (SPI) format.

35. One or more machine-readable storage media comprising a plurality of instructions stored thereon that, in response to being executed, cause a compute device to:
receive, with an out-of-band remote debug logic unit and from a remote compute device, a request to update firmware of the compute device, wherein the request includes updated firmware; and
send, with the out-of-band remote debug logic unit and in response to receipt of the request and in a first format, a write request to a data path management logic unit of the compute device;
convert, with the data path management logic unit, the write request from the first format to a second format, wherein a firmware memory of the compute device is responsive to messages in the second format; and
send, with the data path management logic unit, the converted request to the firmware memory to write the updated firmware to the firmware memory.

36. The one or more machine-readable storage media of claim 35, wherein to write the updated firmware to the firmware memory comprises to write an updated basic input/output system (BIOS) to the firmware memory.

37. The one or more machine-readable storage media of claim 36, wherein the plurality of instructions further cause the compute device to send, before the compute device has been booted, a request to the remote compute device for a firmware update.

38. The one or more machine-readable storage media of claim 37, wherein the plurality of instructions further cause the compute device to determine whether the compute device is unable to boot and wherein to send the request to the remote compute device comprises to send, in response to a determination that the compute device is unable to boot, the request to the remote compute device.

39. The one or more machine-readable storage media of claim 37, wherein to send the request to the remote compute device comprises to send the request to a management server of a data center in which the compute device is located.

40. The one or more machine-readable storage media of claim 35, wherein the plurality of instructions further cause the compute device to:
send, with the out-of-band remote debug logic unit, a read request to the data path management logic unit to read data from the firmware memory; and
send, with the data path management logic unit, read data from the firmware memory to the out-of-band remote debug logic unit in response to the read request.

41. The one or more machine-readable storage media of claim 35, wherein to receive the request to update the firmware of the compute device comprises to receive the request when the compute device has not been booted.

42. The one or more machine-readable storage media of claim 41, wherein the plurality of instructions further cause the compute device to boot with the updated firmware.

43. The one or more machine-readable storage media of claim 35, wherein to receive the request to update the firmware of the compute device comprises to receive a request to update a basic input/output system (BIOS) of the compute device.

44. The one or more machine-readable storage media of claim 35, wherein to convert, with the data path management logic unit, the write request from the first format to a second format comprises to convert the request from a Joint Test Action Group (JTAG) format to a Serial Peripheral Interface (SPI) format.

45. A method comprising:
receiving, with an out-of-band remote debug logic unit of a compute device, a request from a remote compute device to update firmware of the compute device, wherein the request includes updated firmware; and
sending, with the out-of-band remote debug logic unit and in response to receipt of the request and in a first format, a write request to a data path management logic unit of the compute device;
converting, with the data path management logic unit, the write request from the first format to a second format, wherein a firmware memory of the compute device is responsive to messages in the second format; and
sending, with the data path management logic unit, the converted request to the firmware memory to write the updated firmware to the firmware memory.

46. The method of claim 45, wherein writing the updated firmware to the firmware memory comprises writing an updated basic input/output system (BIOS) to the firmware memory.

47. The method of claim 45, further comprising sending, by the compute device and before the compute device has been booted, a request to the remote compute device for a firmware update.

48. The method of claim 47, further comprising determining, by the compute device, whether the compute device is unable to boot and wherein sending the request to the remote compute device comprises sending, in response to a determination that the compute device is unable to boot, the request to the remote compute device.
